(19) United States
(12) Patent Application Publication
(10) Pub. No.: US 2013/0269674 A1
(43) Pub. Date: Oct. 17, 2013

(54) FIRE PIT WITH RADIANT HEAT COOKER

(71) Applicant: Steve Junge, SR., New Athens, IL (US)

(72) Inventor: Steve Junge, SR., New Athens, IL (US)

(21) Appl. No.: 13/856,647

(22) Filed: Apr. 4, 2013

Related U.S. Application Data
(60) Provisional application No. 61/623,134, filed on Apr. 12, 2012.

(51) Int. Cl. A47J 37/07

(52) U.S. Cl. CPC A47J 37/07
USPC 126/30; 126/29

(57) ABSTRACT

A portable fire pit (10) is of a metal construction and has an upper section (12) in which combustible materials are placed for burning. A cooking chamber (14) is mounted beneath the upper section and food placed in the chamber is cooked by radiated heat. Legs (16) are installed at each corner of the fire pit to support the fire pit in an upright position.

### CROSS REFERENCE TO RELATED APPLICATIONS

This application claims the benefit of U.S. Provisional Application Ser. No. 61/623,134, filed Apr. 12, 2012, which is incorporated herein by reference.

### STATEMENT REGARDING FEDERALLY SPONSORED RESEARCH OR DEVELOPMENT

N/A

### BACKGROUND OF THE INVENTION

This invention relates to fire pits and more particularly to a fire pit having a cooking chamber installed beneath the pit for cooking food using radiant heat.

A fire pit comprises a platform supported on legs or a stand so the platform is raised to some level above the ground. Fire pits are commonly used outdoors as a source of heat. That is, a combustible material, usually wood is placed in or on the platform and, when burning, the resulting fire gives off a substantial amount of heat.

In addition to burning wood to warm an area surrounding the fire pit, it is also known to cook food which is placed on or about the platform. Various fire pit constructions or fire pit accessories are known in the art and used for this purpose. See, for example, U.S. Pat. Nos. 7,383,836, 7,063,006, 7,007,687, 6,626,090, 5,598,834, 5,868,128, 5,785,046, 5,297,534, and 4,696,282.

The present invention is directed at using the heat created in the fire pit to cook food placed in chamber conveniently located beneath the pit. Using such a chamber has a number of advantages over the way food is currently cooked on a fire pit or using an accessory such as shown in the various noted patents.

### BRIEF SUMMARY OF THE INVENTION

The present invention comprises a portable fire pit having a recessed upper surface defining a pit for holding a combustible material such as fire wood. A center section of the pit is generally flat and sidewalls of the pit slope inwardly and downwardly from an upper, outer edge of the pit to the center section. Suspended beneath the center section is a pair of brackets extending parallel to each other along opposite sides of the center section. An open-sided cooking chamber is suspended beneath the center section. One or more cooking racks can be inserted into the chamber through its open side. Food to be cooked is placed upon the racks. The food is cooked by heat radiating from the bottom of the fire pit and from the sides and bottom of the chamber. Once the food is cooked, the rack on which it is placed is removed and the food is served.

The cooking chamber is readily installed and removed as are the racks on which the food is placed.

Legs supporting the fire pit are removable for moving and storing the fire pit.

The fire pit is made of a lightweight metal for ease of handling, set-up and take down and storing of the fire pit.

The fire pit is relatively low cost and any damaged parts for the fire pit are easily replaced.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a perspective view of the fire pit from above;

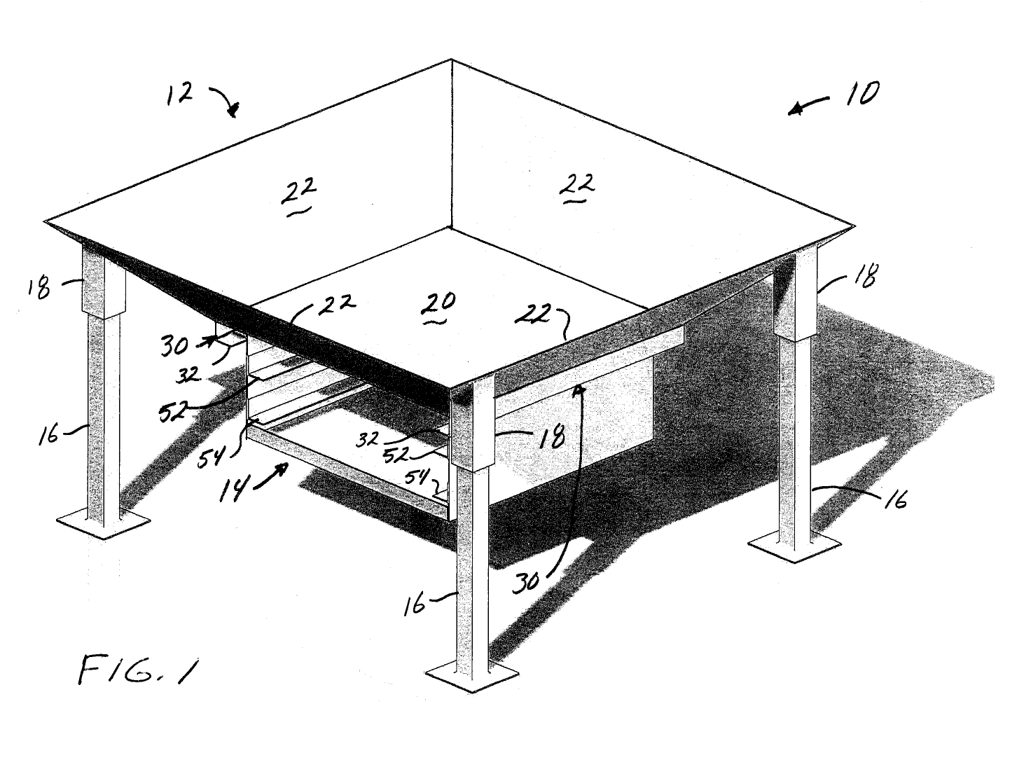

FIG. 2 is a perspective view of the fire pit from below; and.

FIG. 3 is a perspective view of the fire pit when disassembled.

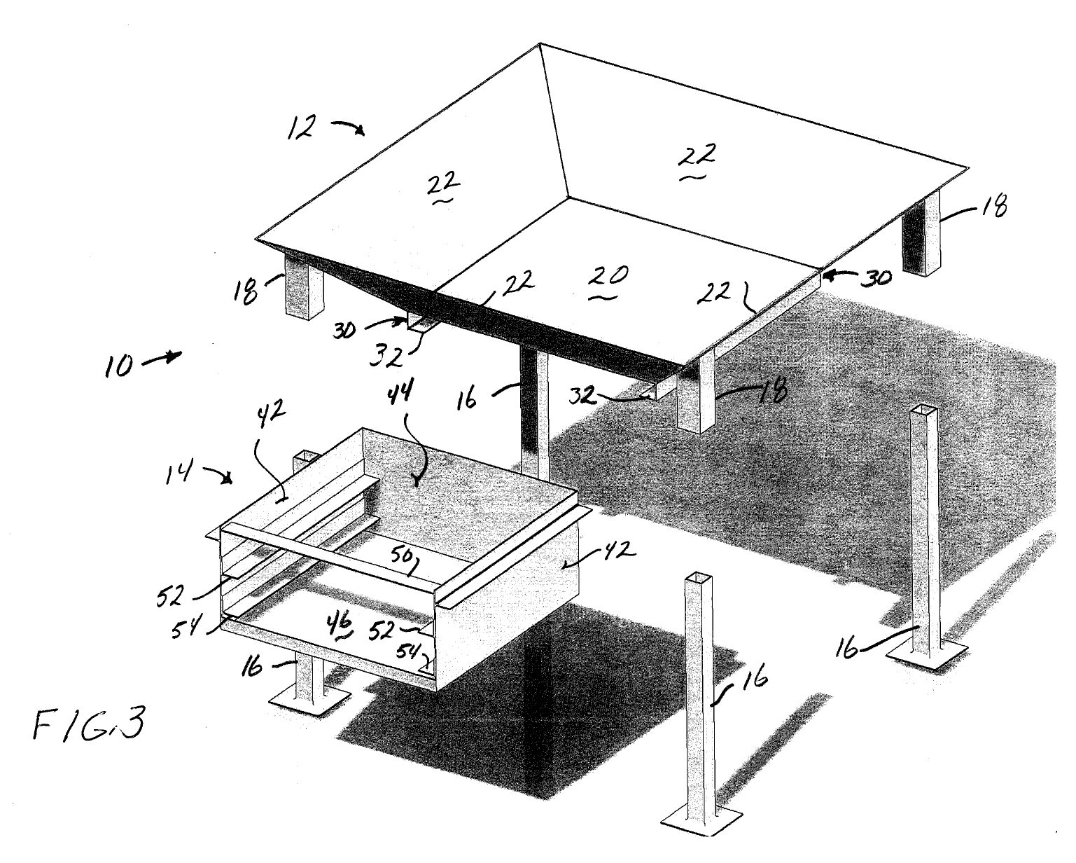

Corresponding reference characters indicate corresponding parts throughout the several views of the drawings.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Referring to the drawings, a portable fire pit of the present invention is indicated generally 10. The fire pit, which is of a metal construction, first has an upper section indicated generally 12 in which fire wood or other combustible materials are placed and which contains the resulting fire when these materials are ignited. Located beneath section 12, and as described hereafter, is a cooking chamber assembly indicated generally 14. Fire pit 10, which is shown to be generally square or rectangular in shape has legs 16 which are installed at each corner of the fire pit to support the fire pit in an upright position. Sockets or brackets 18 in which upper ends of each leg are inserted during assembly of the fire pit are attached to the underside of section 12 at each corner of the fire pit.

In more detail, upper section 12 of fire pit 10 has a recessed upper surface which defines the fire pit. That is, it has a center, flat base 20 which is recessed as shown in the drawings. Base 20 is generally rectangular or square in shape and has four sidewalls 22 each of which slopes inwardly and downwardly from an upper, outer edge of the pit to the center base 20. The depth of the fire pit is such that can conveniently hold a supply of fire wood and/or other combustible materials and safely contain the resulting fire when these are ignited.

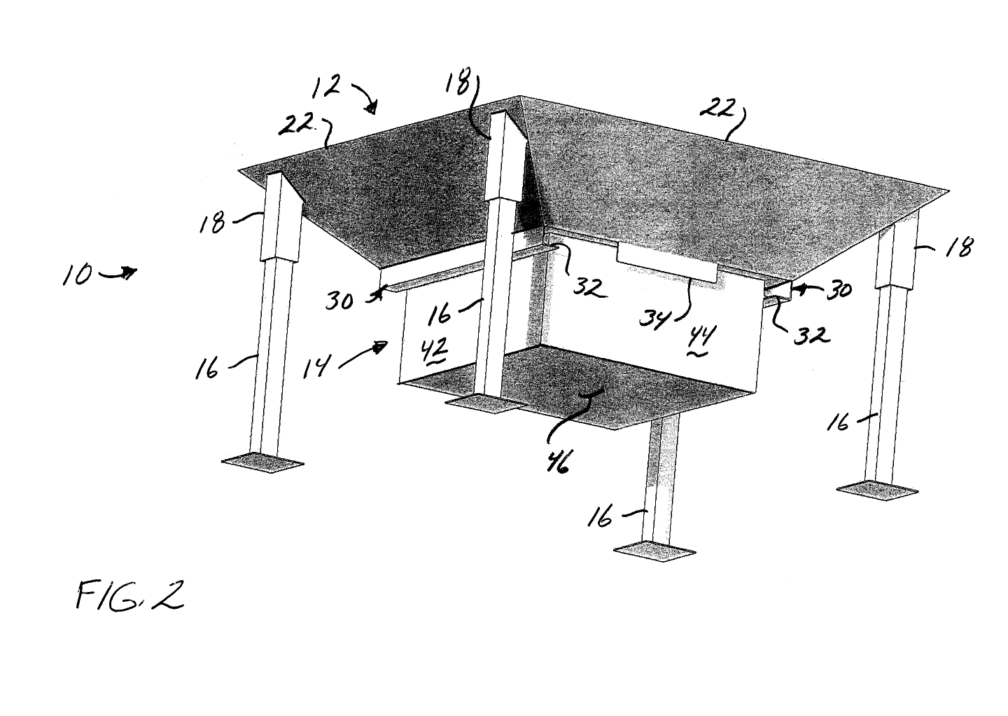

As shown in FIG. 2, a pair of L-shaped support brackets 30 are fitted beneath base 20 of the fire pit 10. The brackets extend along the underside of the base along opposites sides of the base. The length of each bracket corresponds to that of the respective side of the base. The base of each bracket comprises a lip 32 and the brackets are installed so the lips face each other. A rectangular shaped stop 34 is also attached to the underside of base 20 along a third side of the base. The stop is positioned midway along this side of the base.

Cooking chamber 14 is supported on the underside of base 20 by the brackets 30. The cooking chamber has two sidewalls 42, a back wall 44, and a floor or bottom 46. The sides, back and bottom of chamber 14 are welded or glued together, and the front and top of the chamber are both open. A horizontally extending support 48 of an elongate rectangular shape extends outwardly from the upper end of each side 42 of chamber 14, and a reinforcement strip 50 extends between the two sides of the cooking chamber across the top of the open front face of the chamber.

To install the cooking chamber beneath the fire pit, the supports 48 are positioned above the lips 32 of the respective support bracket 30 and the chamber is slid along the underside of base 20 of the fire pit until back wall 44 contacts stop 34. In this position, the cooking chamber is directly beneath the fire pit and heat generated by whatever is burning in the fire pit radiates into the cooking chamber.

As the material in the fire pit burns, heat is transferred from the fire pit down the sidewalls and back wall of chamber 14. Accordingly, food placed in the chamber is cooked by heat radiating downwardly into the chamber from the fire pit, as well as heat radiating into the chamber from the sidewalls and back wall, and upwardly from the floor of the chamber.

Cooking chamber 14 has two shelves inside it. Each shelf is formed by a pair of respective supports 52, 54 extending lengthwise along the inner face of each sidewall 42. One set of supports extends across the top of the sidewalls and the other set along the lower portion thereof. The supports allow two separate racks (not shown) of food to be cooked by radiant heat to be set in the chamber. When food one on rack is cooked, it is readily removed while the other rack can be left in place until the food on it is cooked. It will be appreciated that cooking chamber 14 is readily installed and removed from beneath the fire pit, as are the racks on which the food is placed from the cooking chamber. Those skilled in the art will appreciate that fire pit 10 allows food to be cooked in chamber 14 at the same time food can be placed over the top of the fire pit to be cooked as well.

Fire pit 10 is portable. For this purpose, the upper end each foot 16 is installed in a socket 18 when the fire pit is being erected, and removed from the socket for storage when the fire pit is to be moved to another place or stored. At the base of each foot is a rectangular shaped footpad 56 to distribute the weight of fire pit 10 and increase its stability. While the feet 16 and sockets are each shown to be rectangular in the drawings, they could also be rounded without departing from the scope of the invention.

Finally, fire pit 10 is made of a lightweight metal for ease of handling, set-up and take down and storing of the fire pit.

It will be understood by those skilled in the art that while the fire pit 10 shown and described is rectangular in plan, the fire pit with its under hung cooking chamber could also be available in other shapes. For example, the fire pit could round or oval in plan without departing from the scope of the invention.

In view of the above, it will be seen that the several objects and advantages of the present disclosure have been achieved and other advantageous results have been obtained.

Having thus described the invention, what is claimed and desired to be secured by Letters Patent is:

1. A portable fire pit comprising:
an upper section having a recessed center defining a pit in which combustible material is placed for burning; and,
an open-sided cooking chamber is suspended beneath the center section, at least one cooking rack being inserted into the chamber through its open side with food to be cooked placed upon the rack, the food being cooked by heat radiating from the bottom of the fire pit and from the sides and bottom of the chamber.

2. The fire pit of claim 1 in which the center of the pit is generally flat and sidewalls surrounding the pit slope inwardly and downwardly from an upper, outer edge of the pit to the center thereof.

3. The fire pit of claim 2 further including brackets attached to the underside of the recessed center of the upper section for supporting the cooking chamber.

4. The fire pit of claim 3 in which the cooking chamber includes interior supports for a plurality of racks on which food is placed to be cooked.

5. The fire pit of claim 1 further including support means for supporting the fire pit.

6. The fire pit of claim 5 in which the support means includes a socket on the underside of the upper section at each corned thereof, and a leg removably inserted in the socket to support the fire pit in an upright position.

7. The fire pit of claim 6 in which each leg has a footpad for distributing the weight of the fire pit and providing it stability.
